(19) United States
(12) Patent Application Publication
(10) Pub. No.: US 2026/0292157 A1
(43) Pub. Date: Sep. 24, 2026

(54) A METHOD, AN APPARATUS AND A COMPUTER PROGRAM PRODUCT FOR IMAGE AND VIDEO PROCESSING

(71) Applicant: Nokia Technologies Oy, Espoo (FI)

(72) Inventors: Francesco CRICRÌ, Tampere (FI); Ruiying YANG, Tampere (FI); Maria Claudia SANTAMARIA GOMEZ, Tampere (FI); Nannan ZOU, Tampere (FI); Honglei ZHANG, Tampere (FI); Jani LAINEMA, Tampere (FI); Miska Matias HANNUKSELA, Tampere (FI); Alireza AMINLOU, Tampere (FI)

(21) Appl. No.: 19/471,954

(22) PCT Filed: Mar. 22, 2024
(86) PCT No.: PCT/EP2024/057790

§ 371 Date: Oct. 2, 2025

(30) Foreign Application Priority Data
Apr. 5, 2023 (FI) 20235393

(51) Int. Cl. H04N 19/117; H04N 19/503; H04N 19/593

(52) U.S. Cl. CPC H04N 19/117; H04N 19/503; H04N 19/593

(57) ABSTRACT

The embodiments relate to method comprising receiving as an input at least one signal; decomposing the signal to at least a first decomposed signal and a second decomposed signal; providing the first decomposed signal and the second decomposed signal to a filter; using in the filter a set of neural network layers for processing the first decomposed signal; using in the filter another set of neural network layers for processing the second decomposed signal; and obtaining one or more output signals based on the processed first decomposed signal and the processed second decomposed signal.

### TECHNICAL FIELD

The present solution generally relates to image and video processing.

### BACKGROUND

A neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Video Coding for Machines (VCM) is related to technologies for coding videos such that it be consumable for both human and machine. It has two tracks, the first is video-based coding where an input video is encoded to allow usability mainly by machines. The second track is about coding features.

A class of multimedia codecs, audio, video and image codecs, are emerging with the advance of neural networks (NN). These codecs often contain at least one neural encoder, a neural network that transforms the input data, here data could be audio, video, or image, into a representation which may be more efficiently compressed by a lossless codec than the original input representation of the data. The decoder could also be at least one neural network that decodes such a representation into an output representation, where the output representation may be a machine consumable representation (e.g., in video coding for machine) or a human consumable output (e.g., in neural network-based video coding for human beings).

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to an embodiment, there is provided a method for a neural network based filter, which leverages information present at different frequencies in an input to the filter and/or in data derived from the input to the filter (such as in intermediate representations within the filter) and/or in an output of the filter, when training the filter and/or when running the filter.

According to a first aspect, there is provided an apparatus comprising: means for receiving as an input a signal;
means for decomposing the signal to at least a first decomposed signal and a second decomposed signal based on one or more properties of the signal;
means for providing the first decomposed signal and the second decomposed signal to a filter;
means for using in the filter a set of neural network layers for processing the first decomposed signal;
means for using in the filter another set of neural network layers for processing the second decomposed signal; and
means for obtaining one or more output signals based on the processed first decomposed signal and the processed second decomposed signal.

According to a second aspect, there is provided a method, comprising: receiving as an input a signal;
decomposing the signal to at least a first decomposed signal and a second decomposed signal;
providing the first decomposed signal and the second decomposed signal to a filter;
using in the filter a set of neural network layers for processing the first decomposed signal;
using in the filter another set of neural network layers for processing the second decomposed signal; and
obtaining one or more output signals based on the processed first decomposed signal and the processed second decomposed signal.

According to a third aspect, there is provided an apparatus comprising:
at least one processor; and
at least one memory storing instructions that, when executed by the at least one processor, cause the apparatus at least to:
receive as an input a signal;
decompose the signal to at least a first decomposed signal and a second decomposed signal based on one or more properties of the signal;
provide the first decomposed signal and the second decomposed signal to a filter;
use in the filter a set of neural network layers for processing the first decomposed signal;
use in the filter another set of neural network layers for processing the second decomposed signal; and
obtain one or more output signals based on the processed first decomposed signal and the processed second decomposed signal.

According to a fourth aspect, there is provided computer program product comprising computer program code configured to, when executed on at least one processor, cause an apparatus or a system to:
receive as an input a signal;
decompose the signal to at least a first decomposed signal and a second decomposed signal based on one or more properties of the signal;
provide the first decomposed signal and the second decomposed signal to a filter;
use in the filter a set of neural network layers for processing the first decomposed signal;
use in the filter another set of neural network layers for processing the second decomposed signal; and
obtain one or more output signals based on the processed first decomposed signal and the processed second decomposed signal.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a codec with neural network (NN) components;

FIG. 2 shows an example of a video coding for machines;

FIGS. 3a-3i illustrate some embodiments of neural network based filtering;

FIG. 4 shows an example of using neural network based filtering with scalable image/video coding where a decomposition block is adapted to operate with reconstructed signal of scalability layers;

FIG. 5 shows an example of using different filters for different frequency bands, in cascade, in accordance with an embodiment;

FIG. 6 is a flowchart illustrating a method according to an embodiment; and

FIG. 7 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

Before discussing the present embodiments in more detailed manner, a short reference to related technology is given.

In the context of machine learning, a neural network (NN) is a computation graph consisting of several layers of computation, i.e. several portions of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

One of the properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

While the above background information on neural networks may be valid at the time when this document was written, the field of neural networks and machine learning in general is developing at a fast pace. Thus, it is to be understood that at least some of the embodiments described herein are not limited to the definition of a neural network, or a machine learning model, or a training algorithm that was given in the background information above.

Lately, neural networks have been used for compressing and decompressing data such as images, i.e., in an image codec. The most widely used architecture for realizing one component of an image codec is an auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

The neural-network post-filter characteristics (NNPFC) SEI message and the neural-network post-filter activation (NNPFA) SEI message have been described in document JVET-AB2006.

The NNPFC SEI message comprises the nnpfc_id syntax element, which contains an identifying number that may be used to identify a post-processing filter. A base post-processing filter is the filter that is contained in or identified by the first NNPFC SEI message, in decoding order, that has a particular nnpfc_id value within a coded layer video sequence (CLVS). If there is a second NNPFC SEI message that has the same nnpfc_id value that defines the base post-processing filter, an update relative to the base post-processing filter is applied to obtain a post-processing filter associated with the nnpfc_id value. The update may be obtained by decoding the coded neural network bitstream in the second NNPFC SEI message. Otherwise, the post-processing filter associated with the nnpfc_id value is assigned to be the same as the base post-processing filter.

The NNPFC SEI message comprises nnpfc_mode_idc syntax element, the semantics of which may be defined as follows:
nnpfc_mode_idc equal to 0 specifies that the base post-processing filter or the update relative to the base post-processing filter associated with the nnpfc_id value is a neural network identified by the Uniform Resource Identifier (URI) nnpfc_uri with the format identified by the tag URI nnpfc_tag_uri.
nnpfc_mode_idc equal to 1 indicates that this SEI message contains an ISO/IEC 15938-17 bitstream that specifies the base post-processing filter or updates relative to the base post-processing filter with the same nnpfc_id value.

The NNPFC SEI message may also comprise:
Purpose of the post-processing filter, such as
   Visual quality improvement
   Chroma upsampling from the 4:2:0 chroma format to the 4:2:2 or 4:4:4 chroma format, or from the 4:2:2 chroma format to the 4:4:4 chroma format
   Increasing the width or height of the cropped decoded output picture without changing the chroma format
   Increasing the width or height of the cropped decoded output picture and upsampling the chroma format
   Frame rate upsampling
Formatting of the input tensors that are given as input to the neural network inference
Formatting of the output tensors that are resulting from the neural network inference
Characterization of the complexity of the neural network

The NNPFA SEI message specifies the neural-network post-processing filter that may be used for post-processing filtering for the current picture, or for post-processing filtering for the current picture and one or more other pictures. The NNPFA SEI message comprises the nnpfa_target_id syntax element, which indicates that the neural-network post-processing filter with nnpfc_id equal to nnfpa_target_id may be used for post-processing filtering for the indicated persistence. The indicated persistence may be the current picture only (nnpfa_persistence_flag equal to 0), or until the end of the current CLVS or the next picture, in output order, in the current layer associated with a NNPFA SEI message with the same nnpfa_target_id as the current SEI message (nnpfa_persistence_flag equal to 1).

Reducing distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which contains one or more machines, and runs these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team—Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC. A reference software for VVC is the VVC Test Model (VTM).

A specification of the AV1 bitstream format and decoding process were developed by the Alliance of Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures each comprises of one or more sample arrays, such as one of the following sets of sample arrays:
Luma (Y) only (monochrome),
Luma and two chroma (YCbCr or YcgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that composes a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sub of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

A bitstream may be defined as a sequence of bits, which may in some coding formats or standards be in the form of a network abstraction layer (NAL) unit stream or a byte stream, that forms the representation of coded pictures and associated data forming one or more coded video sequences.

A bitstream format may comprise a sequence of syntax structures.

A syntax element may be defined as an element of data represented in the bitstream. A syntax structure may be defined as zero or more syntax elements present together in the bitstream in a specified order.

A NAL unit may be defined as a syntax structure containing an indication of the type of data to follow and bytes containing that data in the form of a raw byte sequence payload (RBSP) interspersed as necessary with start code emulation prevention bytes. The RBSP may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. It needs to be understood that embodiments may be applied but are not limited to the described types of parameter sets and embodiments could likewise be applied to any parameter set type.

A parameter set may be activated when it is referenced e.g., through its identifier. An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g., ALF, LMCS, or scaling list) and an identifier. In other words, different types of APSs have their own identifier value ranges.

An Adaptation Parameter Set (APS) may comprise parameters for decoding processes of different types, such as adaptive loop filtering or luma mapping with chroma scaling.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified. SEI messages are generally not extended in future amendments or versions of the standard.

A scalable bitstream may include a “base layer” providing the lowest quality video available and one or more enhancement layers that enhance the video quality when received and decoded together with the lower layers. In order to improve coding efficiency for the enhancement layers, the coded representation of that layer may depend on the lower layers. E.g., the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use e.g., with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer.
Spatial scalability: Base layer pictures are coded at a lower resolution (i.e., have fewer samples) than enhancement layer pictures. Spatial scalability and quality scalability may sometimes be considered the same type of scalability.
Bit-depth scalability: Base layer pictures are coded at lower bit-depth (e.g., 8 bits) than enhancement layer pictures (e.g., 10 or 12 bits).
Dynamic range scalability: Scalable layers represent a different dynamic range and/or images obtained using a different tone mapping function and/or a different optical transfer function.
Chroma format scalability: Base layer pictures provide lower spatial resolution in chroma sample arrays (e.g., coded in 4:2:0 chroma format) than enhancement layer pictures (e.g., 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
Region-of-interest (ROI) scalability: An enhancement layer represents a spatial subset of the base layer. ROI scalability may be used together with other types of scalabilities, e.g., quality or spatial scalability so that the enhancement layer provides higher subjective quality for the spatial subset.
View scalability, which may also be referred to as multiview coding. The base layer represents a first set of views, whereas an enhancement layer represents a second set of views.
Depth scalability, which may also be referred to as depth-enhanced coding. A layer or some layers of a bitstream may represent texture view(s), while other layer or layers may represent depth view(s).

In all of the above scalability cases, base layer information could be used to code enhancement layer to minimize the additional bitrate overhead.

Scalability can be enabled in two basic ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame-based scalability, approach can be implemented very efficiently with minimal changes to single layer codecs while still achieving majority of the coding efficiency gains available. Essentially a reference frame-based scalability codec can be implemented by utilizing the same hardware or software implementation for all the layers, just taking care of the DPB management by external means.

In ROI scalability, spatial correspondence of an ROI enhancement layer in relation to its reference layer(s) is indicated. In VVC, scaling windows can be used to indicate this spatial correspondence.

It has been proposed, e.g. in JVET-01150 (https://www.jvet-experts.org/doc_end_user/documents/15_Gothenburg/wg11/JVET-01150-v2.zip), that temporal sublayers could be used for any type of scalability. A mapping of scalability dimensions to sublayer identifiers could be provided e.g. in a VPS or in an SEI message.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Image and video codecs may use a set of filters to enhance the visual quality of the predicted visual content and can be applied either in-loop or out-of-loop, or both. In the case of in-loop filters, the filter applied on one block in the currently-encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content won't be as a source for prediction, and thus it may only impact the visual quality of the frames that are output by the decoder.

An encoder-side device performs a compression or encoding operation of an input video by using a video encoder. The output of the video encoder is a bitstream representing the compressed video. A decoder-side device performs decompression or decoding operation of the compressed video by using a video decoder. The output of the video decoder may be referred to as decoded video. The decoded video may be post-processed by one or more post-processing operations, such as a post-processing filter. The output of the one or more post-processing operations may be referred to as post-processed video.

The encoder-side device may also include at least some decoding operations, for example in a coding loop, and/or at least some post-processing operations. In one example, the encoder may include all the decoding operations and any post-processing operations.

The encoder-side device and the decoder-side device may be the same physical device, or different physical devices.

Recently, neural network (NNs) have been used in the context of image and video compression.

NN-based codecs may use an ensemble of neural networks to encode or decode the data. Using ensembles, several (more than one) neural networks are used to perform one task and a combination of their results is used as the final output. One aspect of the ensemble-based coding is that there is no unique ensemble so people have to choose a trade-off between the quality and the number of NNs in the ensemble. Nevertheless, ability to dynamically choose the correct ensemble configuration could benefit the overall quality.

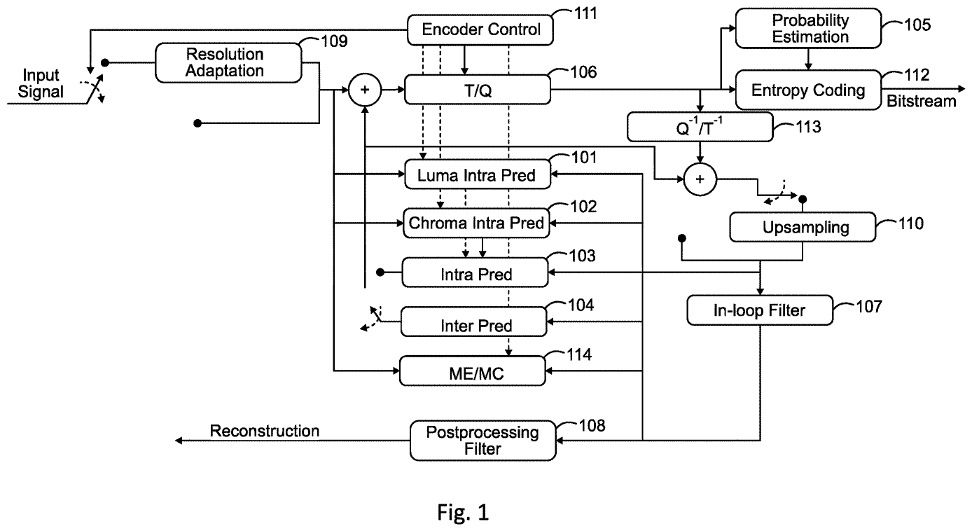

FIG. 1 illustrates examples of functioning of NNs as components of a codec's pipeline, in accordance with an embodiment. FIG. 1 illustrates an encoder, which also includes a decoding loop. FIG. 1 is shown to include components described below.

A luma intra pred block or circuit 101 performs intra prediction in the luma domain, for example, by using already reconstructed data from the same frame. The operation of the luma intra pred block or circuit 101 may be performed by a deep neural network such as a convolutional auto-encoder.

A chroma intra pred block or circuit 102 performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.

An intra pred block or circuit 103 and inter-pred block or circuit 104 perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.

A probability estimation block or circuit 105 for entropy coding performs prediction of probability for the next symbol to encode or decode, which is then provided to the entropy coding module 112, such as the arithmetic coding module, to encode or decode the next symbol. The operation of the probability estimation block or circuit 105 may be performed by a neural network.

A transform and quantization (T/Q) block or circuit 106 are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.

Operations of an in-loop filter block or circuit 107 are performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.

A postprocessing filter block or circuit 108 may be performed only at a decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.

A resolution adaptation block or circuit 109 may downsample the input video frames, prior to encoding. Then, in the decoding loop, the reconstructed data may be upsampled by the upsampling block or circuit 110 to the original resolution. The operation of the resolution adaptation block or circuit 109 block or circuit may be performed by a neural network such as a convolutional auto-encoder.

An encoder control block or circuit 111 performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.

An ME/MC block or circuit 114 performs motion estimation and/or motion compensation, which are two key operations to be performed when performing inter-frame prediction. ME/MC stands for motion estimation/motion compensation.

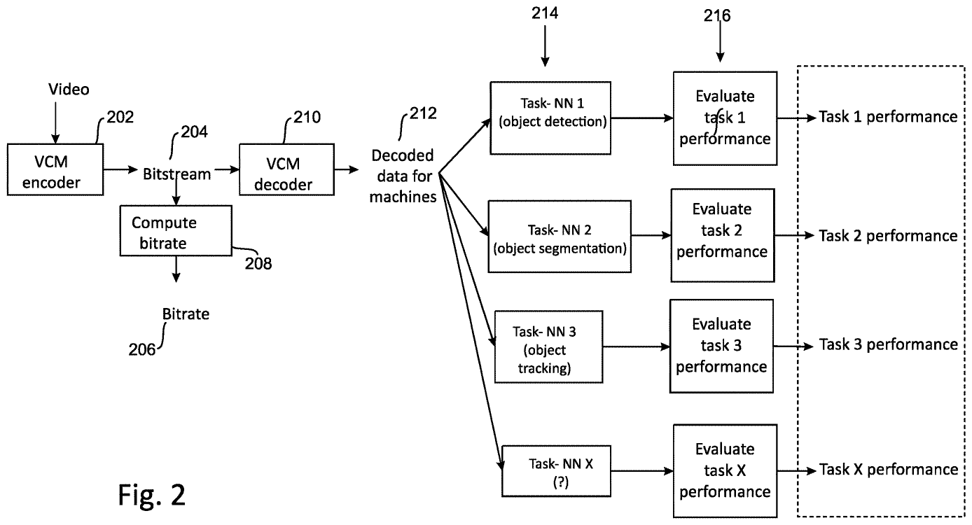

FIG. 2 is a general illustration of the pipeline of Video Coding for Machines. A VCM encoder 202 encodes the input video into a bitstream 204. A bitrate 206 may be computed 208 from the bitstream 204 in order to evaluate the size of the bitstream. A VCM decoder 210 decodes the bitstream output by the VCM encoder 202. In FIG. 2, the output of the VCM decoder 210 is referred to as “Decoded data for machines” 212. This data may be considered as the decoded or reconstructed video. However, in some implementations of this pipeline, this data may not have the same or similar characteristics as the original video which was input to the VCM encoder 202. For example, this data may not be easily understandable by a human when rendering the data onto a screen. The output of VCM decoder is then input to one or more task neural networks 214. In the figure, for the sake of illustrating that there may be any number of task-NNs 214, there are three example task-NNs, and a non-specified one (Task-NN X). The goal of VCM is to obtain a low bitrate representation of the input video while guaranteeing that the task-NNs still perform well in terms of the evaluation metric 216 associated to each task.

When a conventional video encoder, such as a H.266/VVC encoder, is used as a VCM encoder, one or more of the following approaches may be used to adapt the encoding to be suitable to machine analysis tasks:

According to an approach, one or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
A quantization parameter (QP) may be adjusted spatially in a manner that ROIs are encoded using finer quantization step size(s) than other regions. For example, QP may be adjusted coding treen unit (CTU)-wise.
The video is preprocessed to contain only the ROIs, while the other areas are replaced by one or more constant values or removed.
A grid is formed in a manner that a single grid cell covers a ROI. Grid rows or grid columns that contain no ROIs are downsampled as preprocessing to encoding.

According to an approach, a quantization parameter of the highest temporal sublayer(s) is increased (i.e. coarser quantization is used) when compared to practices for human watchable video.

According to an approach, the original video is temporally downsampled as preprocessing prior to encoding. A frame rate upsampling method may be used as postprocessing subsequent to decoding, if machine analysis at the original frame rate is desired.

According to one approach, a filter is used to preprocess the input to the conventional encoder. The filter may be a machine learning based filter, such as a convolutional neural network.

In some video codecs, a neural network may be used as a filter in the decoding loop, and it may be referred to as a neural network loop filter, or neural network in-loop filter. The NN loop filter may replace one or more loop filters of an existing video codec or may represent an additional loop filter with respect to the already present loop filters in an existing video codec. In the context of image and video enhancement, a neural network may be used as a post-processing filter, for example applied to the output of an image or video decoder in order to remove or reduce coding artifacts.

Later in this specification some embodiments will be described which concern the architecture of neural networks used as a part of the decoding operations (such as a NN loop filter, or an intra-frame prediction NN, or an inter-frame prediction NN) or as a part of post-processing operations (a NN post-processing filter). Also, signaling of information related to those NNs will be concerned by some embodiments, where the information is signaled from an encoder to a decoder.

The following example system will be used in several embodiments to illustrate or describe the idea. The example system comprises a codec that comprises one or more NN loop filters. For example, the codec could comprise a modified VVC/H.266 compliant codec (e.g., a VVC/H.266 compliant codec that has been modified so that it would comprise one or more NN loop filters). The input to the one or more NN loop filters may comprise at least a reconstructed block or frames (simply referred to as reconstruction) or data derived from a reconstructed block or frame (e.g., the output of a conventional loop filter). The reconstruction may be obtained based on predicting a block or frame (e.g., by means of intra-frame prediction or inter-frame prediction) and performing residual compensation. The one or more NN loop filters, which may simply be referred to as NN filters in some of the embodiments, may enhance the quality of at least one of their input, so that a rate-distortion loss is decreased. The rate may indicate a bitrate (estimate or real) of the encoded video. The distortion may indicate a pixel fidelity distortion or a machine analysis related distortion, such as one or more of the following:
Mean-squared error (MSE)
Mean absolute error (MAE)
Mean Average Precision (mAP) computed based on the output of a task NN (such as an object detection NN) when the input is the output of the codec that comprises one or more NN loop filters.
Other machine task-related metric, for tasks such as object tracking, video activity classification, video anomaly detection, etc.

The enhancement may result into a coding gain, which can be expressed for example in terms of BD-rate (Bjontegaard Delta rate) or BD-PSNR (Peak Signal to Noise Ratio).

However, at least some of the embodiments described herein may also be applicable to a NN filter which is not a loop filter of a codec. For example, the NN filter may be a NN post-processing filter, whose input may comprise one or more outputs of a video codec. In this case, the filter may be used only for increasing a quality metric of at least one of its inputs, where the quality metric may be, for example, peak signal-to-noise ratio (PSNR), mAP for object detection, MOTA (Multiple Object Tracking Accuracy) for object tracking, etc.

In this specification, for the sake of simplicity, at least some embodiments are described as applied to a filter. A filter takes as input at least one or more first images to be filtered and outputs at least one or more second images, where the one or more second images are the filtered version of the one or more first images. In one example, the filter takes as input one image and outputs one image. In another example, the filter takes as input more than one image and outputs one image. In another example, the filter takes as input more than one image and outputs more than one image.

It is to be understood that a filter may take as input also other data (also referred to as auxiliary data) than the data that is to be filtered, such as data that can aid the filter to perform a better filtering than if no auxiliary data was provided as input. In one example, the auxiliary data comprises information about prediction data, and/or information about the picture type, and/or information about the slice type, and/or information about a Quantization Parameter (QP) used for encoding, and/or information about boundary strength, etc. In one example, the filter takes as input one image and other data associated to that image, such as information about the quantization parameter (QP) used for quantizing and/or dequantizing that image, and outputs one image.

A filter may be a neural network based filter or may be another type of filter. However, several embodiments describe training aspects which may be applicable to machine learning based filters such as neural network based filters.

A filter may be, for example, an in-loop filter that is used in the decoding loop of a codec, or a post-processing filter applied on the data decoded by the codec.

Even if at least some of the embodiments are described with reference to a filter, those embodiments may also be applied to other operations than just filters, such as an operation performing intra-frame prediction, or an operation performing inter-frame prediction, or an operation performing frame-rate upsampling, or an operation performing encoding and/or decoding (e.g., an end-to-end learned codec).

While at least some embodiments are described such that the input and output data are in the form of images or (video) frames or pictures, those embodiments may be applicable also to other types of data, such as audio frames. Furthermore, while at least some embodiments are described by considering a full image, those embodiments may be applicable also to one or more blocks or portions of an image.

In the following some embodiments will be described in more detail. There are provided methods to leverage information present in different decompositions of a signal, such as in different decompositions of an input to a filter and/or in different decompositions of an intermediate signal within the filter and/or in different decompositions of an output signal from the filter, when training the filter and/or when running the filter. At least some of the described embodiments propose to treat the information present in different decompositions of a signal in different ways when training the filter and/or running the filter.

A signal may be decomposed into multiple signals by means of several possible methods. Such signals may be referred to as decomposed signals or decompositions. As a way of example, most of the embodiments are described in terms of frequency-based decomposition, but any other suitable decomposition method may be used.

For simplicity, the information present at different frequencies in a signal may sometimes be referred to as spectral information. The spectral information of a signal may be divided into one or more frequency bands (i.e., one or more frequency ranges).

In this specification a “signal (e.g., an input signal, or an output signal) of a certain frequency band” means a signal that does not comprise information at frequencies outside of that frequency band, or a signal that substantially does not comprise information at frequencies outside of that frequency band. In other words, the signal is mostly or totally within that frequency band.

It is to be understood that, even if at least some of the embodiments and/or examples are described in terms of decomposing a signal into two signals of respective two frequency bands, those embodiments may be applicable to the case where a signal is decomposed into more than two signals of respective more than two frequency bands.

In order to decompose an image based on frequency information into signals of different frequency bands, several methods may be used, such as, but not limited to, transform-based decompositions. An example of the transform-based decomposition comprises using a Wavelet transform (e.g., Discrete Wavelet Transform). Another example of transform-based decomposition comprises using a Cosine transform (e.g., Discrete Cosine Transform).

It is to be understood that other image decompositions than the frequency-based decompositions may be applicable to at least some of the described embodiments. For example, a signal (e.g., an image or data derived from an image) may be downsampled using different downsampling factors, obtaining a first set of signals at different resolutions. Signals in the first set of signals may then be upsampled to the original version of the signals, obtaining a second set of signals. The second set of signals represents the decomposed signal. Similar results may be obtained by smoothing a signal using different smoothing factors or strengths, where the smoothed signals represent the decomposed signal.

According to another example, bitplane decompositions may be used. A discrete signal (e.g., an image or data derived from an image) is usually represented as a binary string of a certain length expressed in number of bits. Several signals may be obtained from an input signal by using different subsets of the bits of the input signal. The signals obtained this way represent the decomposed signal. It is noted that in one embodiment, only the least-significant bitplanes or bits (LSB) may be filtered (for example, because a small error in more significant bitplanes may have negative effect on quality).

According to yet another example, an image may be decomposed into or represented as an illumination (shading) image and a reflectance (albedo) image that represent the decomposed image, where shading accounts for illumination effects due to geometry, shadows, inter-reflections, and reflectance indicates how object surface materials reflect light.

According to a still further example, an image may be decomposed into or represented as a texture image and a structure image (e.g., structure may be represented by depth information).

According to some further examples, a signal (e.g., an image or data derived from an image) may be decomposed into or represented as components derived based at least on Principal Component Analysis; or a signal may be decomposed into several signals by means of using “coupling layers”.

The following conventions are used in at least some of the figures:
Cross-hatched boxes or blocks represent boxes or blocks used both at training time and at inference time.
White-colored boxes represent boxes that are used only at training time.
Diagonally hatched boxes or blocks represent boxes or blocks that are used both at training and inference time, but may or may not be trainable (e.g., may or may not comprise learnable parameters).

### Training-Only Embodiment

In the following, a training-only embodiment will be described in more detail.

In one embodiment, spectral information is leveraged when training the filter, as follows. The output of the filter is decomposed into two or more signals of respective two or more frequency bands, obtaining respective two or more decomposed filter outputs. A ground-truth is also decomposed into two or more signals of respective two or more frequency bands, obtaining respective two or more decomposed ground-truths. Two or more losses are computed based on the respective two or more decomposed filter outputs and the respective two or more decomposed ground-truths. The loss functions for computing the two or more losses may be chosen according to the frequency bands to which they are applied.

The losses computed by means of the two or more loss functions may be differentiated with respect to one or more parameters of the filter, in order to compute respective one or more gradients. The one or more gradients are used by an optimization function, such as Stochastic Gradient Descent (SGD) or Adam, to update or train the filter.

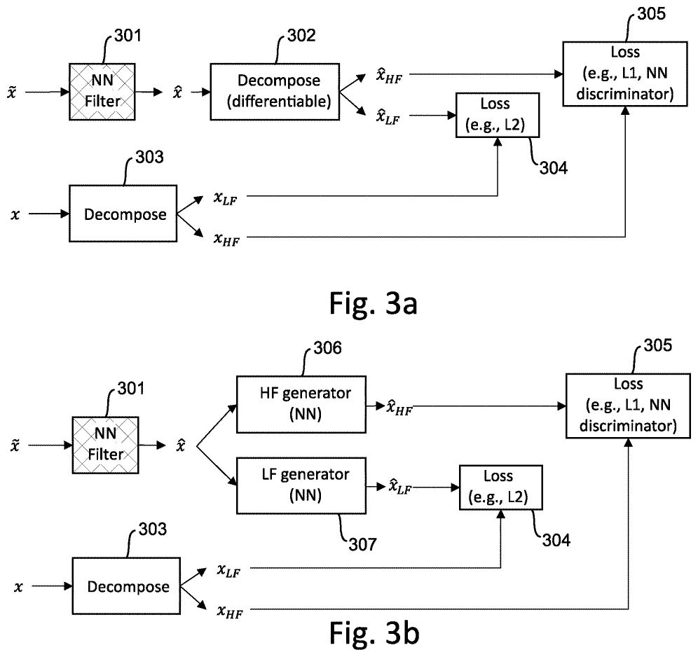

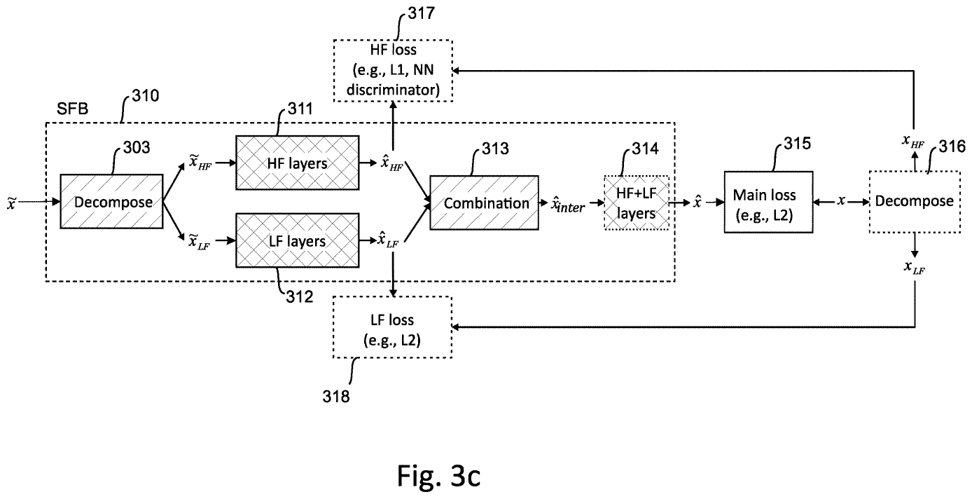

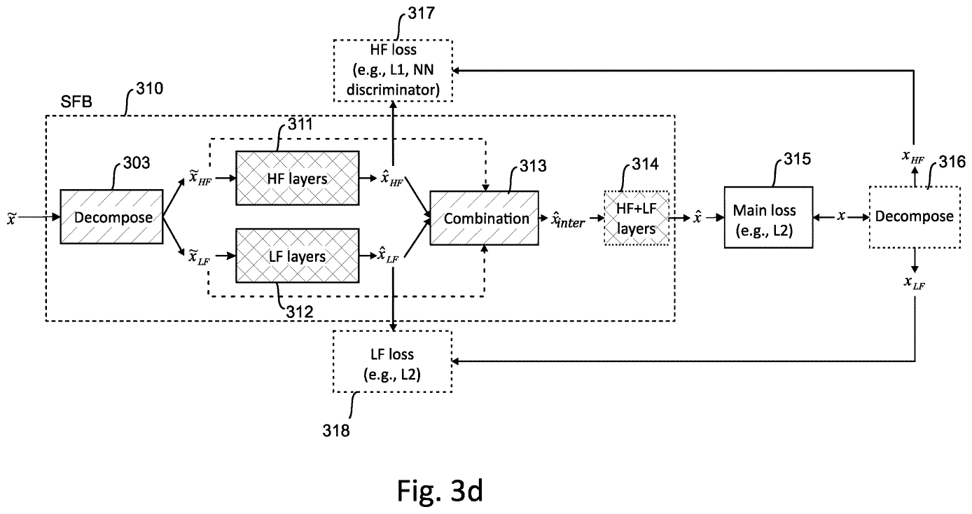

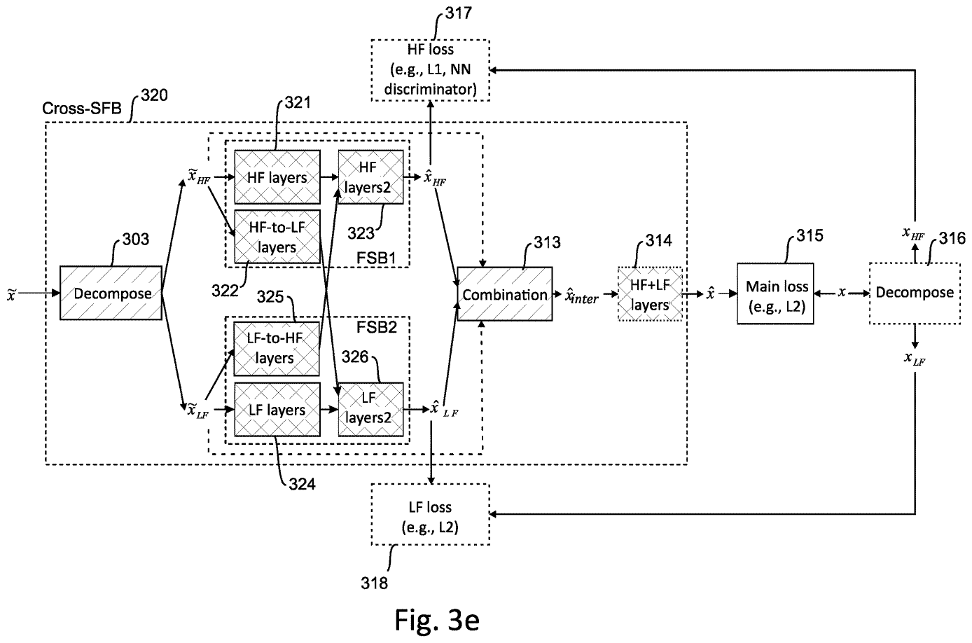

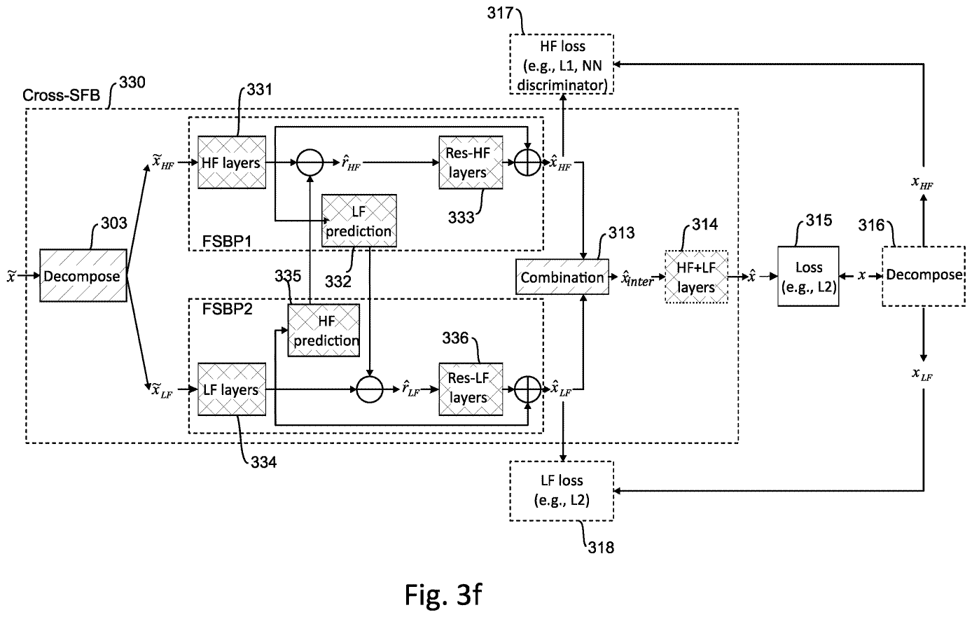

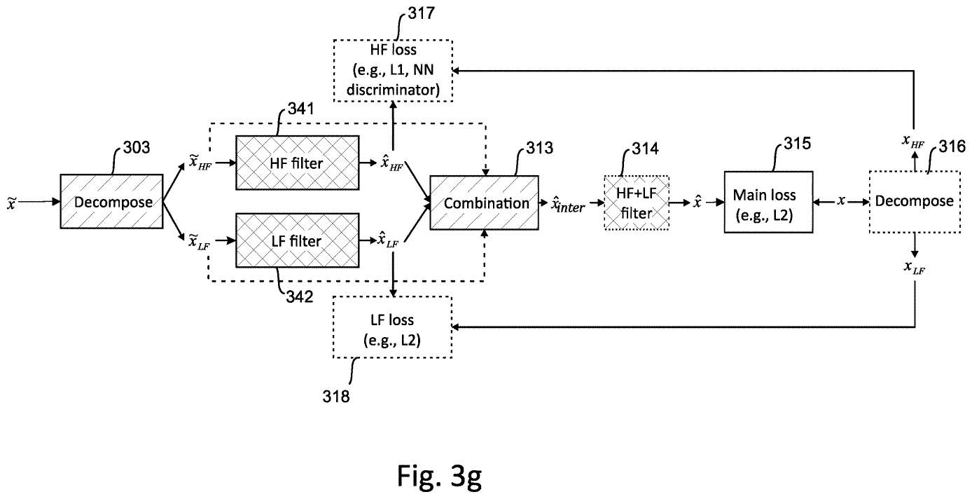

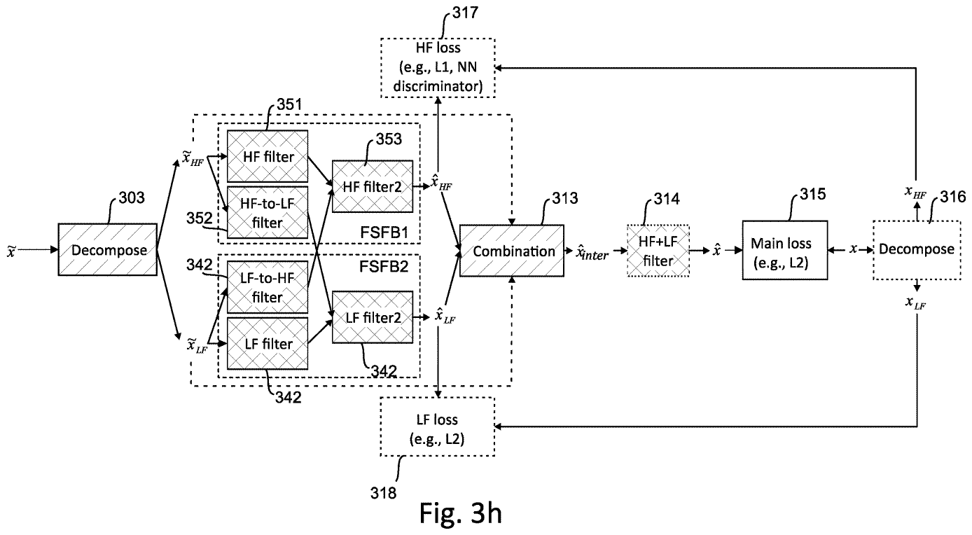

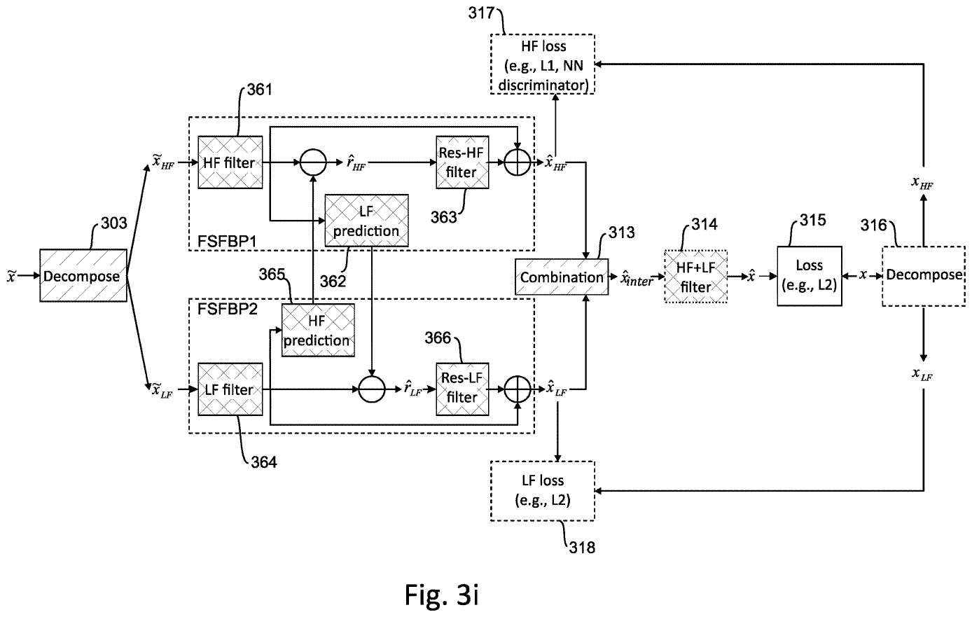

FIG. 3a illustrates an example of this embodiment. In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. The signal x is a ground-truth associated to the input \tilde{x} of the filter; for example, x is an uncompressed picture given as an input to a video encoder, and \tilde{x} is a noisy picture that is generated by the video encoder or a video decoder based on x.

The NN filter block 301 represents a neural network based filter. The output of the filter is indicated as \hat{x}, and is input to a differentiable decompose block 302 (“Decompose (differentiable)”), which decomposes its input \hat{x}, into two signals \hat{x}_{HF} and \hat{x}_{LF}, where \hat{x}_{HF} is a signal of high-frequency band (also simply referred to as high-frequency signal), representing the high-frequency information of \hat{x}, and \hat{x}_{LF} is a signal of low-frequency band (also simply referred to as low-frequency signal), representing the low-frequency information of \hat{x}. The differentiable decompose block 302 is a differentiable function or operation, so that it is possible to compute gradients of its output with respect to its input. For example, it could comprise performing a low-pass filtering with a differentiable convolutional operator, to obtain \hat{x}_{LF}, followed by subtracting \hat{x}_{LF} from \hat{x} to obtain \hat{x}_{HF}. The decompose block 303 takes in the ground-truth x and outputs two signals x_{LF} and x_{HF}, where x_{LF} represents the low-frequency information of x and x_{HF} represents the high-frequency information of x. The differentiable decompose block 302 and the decompose block 303 may perform the same or substantially the same operation. For example, both the differentiable decompose block 302 and the decompose block 303 may decompose their input signal into two signals of same or substantially same frequency bands. A first loss is computed by first loss computation block 304 (“Loss (e.g., L2)”) based at least on \hat{x}_{LF}, x_{LF} and a first loss function (e.g., an L2 function). A second loss is computed by a second loss computation block 305 (“Loss (e.g., L1, NN discriminator)”) based at least on \hat{x}_{HF}, x_{HF} and a second loss function. The second loss function may be, for example, an L1 function, or a neural network discriminator that may be pretrained or trained jointly with the filter. The first loss function and the second loss function may be the same or different loss functions. In FIG. 3a, the L2 function was chosen for the low-frequency information as it is known to perform well for such a situation; instead, the L1 or a NN discriminator were chosen for the high-frequency information as they are known to perform well for such a situation.

FIG. 3b illustrates an example of this embodiment.

In this figure and example, the only difference with respect to the previous figure (FIG. 3a) and example is that the decomposition of the output of the filter 301, x, into two decomposed signals \hat{x}_{HF} and \hat{x}_{LF} is performed by two neural networks indicated as “HF generator (NN)” 306 and “LF generator (NN)” 307, respectively. These two neural networks may be pretrained (e.g., may have been trained in a previous stage with respect to the stage when the filter is trained), or may be trained jointly with the filter.

### A Filtering Block for a NN Filter

FIG. 3c illustrates an example of this embodiment, where a neural network based filter comprises only one instance of the spectral filtering block 310.

In one embodiment, spectral information is leveraged within a filtering block, which is referred to here as a spectral filtering block (SFB) 310, for a neural network based filter. The input to the spectral filtering block 310 may be decomposed into two or more frequency bands, obtaining respective two or more decomposed inputs. The two or more decomposed inputs may be processed by respective two or more sets of neural network layers. The outputs of the two or more sets of neural network layers may be combined, obtaining a combined output. The combined output may be processed by a final set of neural network layers.

In an additional embodiment, the combined output may be obtained based on the outputs of the two or more sets of neural networks layers and based on the two or more decomposed inputs.

During training, a first loss may be computed based at least on the combined output or on the output of the final set of neural network layers, and based on a first loss function. Two or more second losses may be computed based at least on the outputs of the respective two or more sets of neural network layers and on respective two or more signals that are obtained by decomposing the ground-truth, and based on respective two or more second loss functions. The first loss and/or the two or more second losses may be differentiated with respect to one or more parameters of the spectral filtering block 310 and/or one or more parameters of other neural network layers in the filter, in order to compute respective one or more gradients. The one or more gradients are used by an optimization function, such as Stochastic Gradient Descent (SGD) or Adam, to update or train the filter.

In a neural network based filter, there may be one or more instances of the spectral filtering block 310 described in this embodiment. Two different instances of the spectral filtering block 310 may share none, some or all of the parameters that parametrize those instances, where sharing parameters among different instances refers to assigning the same value to corresponding parameters of those instances. In one example, a neural network based filter comprises only one instance of the spectral filtering block 310 and comprises also other neural network layers and operations. In another example, a neural network based filter comprises several instances of the spectral filtering block 310, where the several instances do not share parameters, and comprises also other neural network layers and operations.

In FIG. 3c, \tilde{x} is an input to the filter 310, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input \tilde{x} of the filter; for example, x is an uncompressed picture given as an input to a video encoder, and \tilde{x} is a noisy picture that is generated by the video encoder or a video decoder based on x. The input \tilde{x} is provided as an input to an instance of the spectral filtering block 310. The input to the spectral filtering block 310 is input to a decompose block 303, which decomposes it into two signals \tilde{x}_{HF} and \tilde{x}_{LF}, where \tilde{x}_{HF} represents the high-frequency information of \tilde{x} and \tilde{x}_{LF} represents the low-frequency information of \tilde{x}. A first set of NN layers, denoted as “HF layers” 311, takes the high-frequency signal \tilde{x}_{HF} as input and outputs a first output \hat{x}_{HF}. A second set of NN layers, denoted as “LF layers” 312, takes the low-frequency signal \tilde{x}_{LF} as input and outputs a second output \hat{x}_{LF}. The first output and second output are combined by means of a combination block 313 that performs a combination operation, obtaining an intermediate picture \hat{x}ᵢₙₜₑᵣ.

In one example, the combination may take as input also the two signals \tilde{x}_{HF} and \tilde{x}_{LF}. In another example, the combination may take as input also the signal \tilde{x}. The intermediate picture \hat{x}ᵢₙₜₑᵣ may optionally be input to a third set of layers denoted as “HF+LF layers” 314, obtaining a third output that represents the output \hat{x} of the spectral filtering block 310. In one example, the third output \hat{x} may be combined with the signal \tilde{x}. Alternatively, if the third set of layers is not used, the intermediate filtered image \hat{x}ᵢₙₜₑᵣ represents the output x of the spectral filtering block 310. This is illustrated in FIG. 3d.

During training, the output \hat{x} of the spectral filtering block 310 and the ground-truth x are used to compute a first loss, for example based on the L2 loss function 315. Optionally, a second loss and a third loss may be computed as follows: the ground-truth \tilde{x} is decomposed by a second decompose block 316 into the high-frequency signal x_{HF} and the low-frequency signal x_{LF}; the decompose block 303 and the decompose block 316 may perform the same or substantially the same operation. For example, both the block 303 and the decompose block 316 may decompose their input signal into two signals of same or substantially same frequency bands. The second loss is computed by a HF loss block 317 (“HF loss (e.g., L1, NN discriminator)”) based on \hat{x}_{HF}, x_{HF} and, for example, based on an L1 loss function; the third loss is computed by a LF loss block 318 (“LF loss (e.g., L2)”) based on \hat{x}_{LF}, x_{LF} and, for example, based on an L2 loss function. The first loss and, eventually the second and third losses are used for training one or more parameters of the spectral filtering block 310.

A Filtering Block for a NN Filter, with Exchange of Information Between Different Frequency Bands

In one embodiment, spectral information is leveraged within a filtering block, which is referred to here as cross spectral filtering block (cross-SFB) 320, for a neural network based filter. The input to the filtering block may be decomposed into two or more frequency bands, obtaining respective two or more decomposed inputs. The two or more decomposed inputs may be processed by respective two or more sets of neural network layers, denoted as frequency-specific blocks (FSBs). Each FSB may take two inputs, where a first input may be one of the decomposed inputs, and a second input may be an intermediate output of another FSB. Each FSB may comprise a first set of NN layers, a second set of NN layers and a third set of NN layers. The first set of NN layers takes as input the first input to the FSB and outputs a first output. The second set of NN layers takes as input the first input to the FSB and outputs a second output that represents an intermediate output of this FSB. The third set of NN layers takes as input the first output and the intermediate output of another FSB (e.g., the second input), and outputs a third output which represents the output of the FSB. The outputs of the two or more FSBs may be combined, obtaining a combined output. The combined output may be processed by a final set of neural network layers.

During training, a first loss may be computed based at least on the combined output or on the output of the final set of neural network layers, and based on a first loss function. Two or more second losses may be computed based at least on the outputs of the respective two or more sets of neural network layers (e.g., two or more FSBs) and on respective two or more signals that are obtained by decomposing the ground-truth, and based on respective two or more second loss functions. The first loss and/or the two or more second losses may be differentiated with respect to one or more parameters of the cross spectral filtering block and/or one or more parameters of other neural network layers in the filter, in order to compute respective one or more gradients. The one or more gradients are used by an optimization function, such as Stochastic Gradient Descent (SGD) or Adam, to update or train the filter.

In a neural network based filter, there may be one or more instances of the cross spectral filtering block described in this embodiment. Two different instances of the cross spectral filtering block may share none, some or all of the parameters that parametrize those instances, where sharing parameters among different instances refers to assigning the same value to corresponding parameters of those instances. In one example, a neural network based filter comprises only one instance of the cross spectral filtering block and comprises also other neural network layers and operations. In another example, a neural network based filter comprises several instances of the cross spectral filtering block, where the several instances do not share parameters, and comprises also other neural network layers and operations.

FIG. 3e illustrates an example of this embodiment, where a neural network based filter comprises only one instance of the cross spectral filtering block 320.

In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input \tilde{x} of the filter; for example, x is an uncompressed picture given as input to a video encoder, and \tilde{x} is a noisy picture that is generated by the video encoder or a video decoder based on x.

The input \tilde{x} is provided as input to an instance of the cross spectral filtering block 320. The input to the cross spectral filtering block 320 is input to a decompose block 303, which decomposes it into two signals \tilde{x}_{HF} and \tilde{x}_{LF}, where \tilde{x}_{HF} represents the high-frequency information of \tilde{x} and \tilde{x}_{LF} represents the low-frequency information of \tilde{x}. The two signals \tilde{x}_{HF} and \tilde{x}_{LF} are input to respective two frequency-specific blocks denoted as FSB1 and FSB2. Each frequency-specific block (e.g., FSB1) takes two inputs, where a first input is a decomposed input, and a second input is an intermediate output of the other frequency-specific block (e.g., FSB2). Each frequency-specific block comprises a first set of NN layers (e.g., HF layers), a second set of NN layers (e.g., HF-to-LF layers) and a third set of NN layers (e.g., HF layers2).

In the first frequency-specific block FSB1 the first set of NN layers (e.g., HF layers 321) takes as input the first input (e.g., \tilde{x}_{HF}) to the frequency-specific block and outputs a first output. The second set of NN layers 322 takes as input the first input (e.g., \tilde{x}_{HF}) to the frequency-specific block and outputs a second output that represents an intermediate output of this frequency-specific block. The third set of NN layers 323 takes as input the first output and the intermediate output of the other frequency-specific block FSB2 (e.g., the output of block 325), and outputs a third output which represents the output of this frequency-specific block FSB1.

In the second frequency-specific block FSB2 the first set of NN layers (e.g., LF layers 324) takes as input the first input (e.g., \tilde{x}_{LF}) to the frequency-specific block and outputs a first output. The second set of NN layers 325 takes as input the first input (e.g., \tilde{x}_{LF}) to the frequency-specific block and outputs a second output that represents an intermediate output of this frequency-specific block. The third set of NN layers 326 takes as input the first output and the intermediate output of the other frequency-specific block FSB1 (e.g., the output of block 322), and outputs a third output which represents the output of this frequency-specific block FSB2.

The outputs of the two frequency-specific blocks FSB1, FSB2 are combined by means of a combination block 313 that performs a combination operation, obtaining an intermediate picture \hat{x}ᵢₙₜₑᵣ. In one example, the combination may take as input also the two signals \tilde{x}_{HF} and \tilde{x}_{LF}. In another example, the combination may take as input also the signal \tilde{x}. The intermediate picture \hat{x}ᵢₙₜₑᵣ may optionally be input to a fourth set of layers denoted as “HF+LF layers” 314, obtaining a fourth output that represents the output \hat{x} of the cross spectral filtering block 320. Alternatively, when the fourth set of layers is not used, the intermediate filtered image \hat{x}ᵢₙₜₑᵣ represents the output \hat{x} of the cross spectral filtering block 320.

During training, the output \hat{x} of the cross spectral filtering block 320 and the ground-truth x are used to compute a first loss, for example based on the L2 loss function. Optionally a second and third losses are computed as follows: the ground-truth \tilde{x} is decomposed by the decompose block 316 into the high-frequency signal x_{HF} and the low-frequency signal x_{LF}; the decompose block 303 and the decompose block 316 may perform the same or substantially the same operation. For example, both the decompose block 303 and the decompose block 316 may decompose their input signal into two signals of same or substantially the same frequency bands. The second loss is computed by the HF loss block 315 based on \hat{x}_{HF}, x_{HF} and, for example, based on an L1 loss function; the third loss is computed by the LF loss block 316 based on \hat{x}_{LF}, x_{LF} and, for example, based on an L2 loss function. The first loss and, eventually the second and third losses are used for training one or more parameters of the cross spectral filtering block 320.

A Filtering Block for a NN Filter, with Prediction of a Frequency Band Based on Another Frequency Band

In one embodiment, spectral information is leveraged within a filtering block, which is referred to here as a cross-prediction spectral filtering block 330 (crossPred-SFB), for a neural network based filter. The input to the cross-prediction spectral filtering block 330 may be decomposed into two or more frequency bands, obtaining respective two or more decomposed inputs. The two or more decomposed inputs may be processed by respective two or more sets of neural network layers, denoted as frequency-specific blocks with prediction (FSBPs). An FSBP may comprise a first set of NN layers, a second set of NN layers and a third set of NN layers. An FSBP takes as input a decomposed input and a prediction of the decomposed input, where the prediction of the decomposed input is an intermediate output of another FSBP. The first set of NN layers takes as input the decomposed input and outputs a first output. The prediction of the decomposed input is subtracted from the first output, obtaining a residual. The second set of NN layers takes as input the first output and outputs a second output which represents a prediction of a decomposed input that is input to another FSBP. The third set of NN layers takes as input the residual and outputs a third output. The third output is added to the first output to form a fourth output which represents the output of the FSBP. The outputs of the two or more FSBPs may be combined, obtaining a combined output. The combined output may be processed by a final set of neural network layers.

During training, a first loss may be computed based at least on the combined output or on the output of the final set of neural network layers, and based on a first loss function. Two or more second losses may be computed based at least on the outputs of the respective two or more sets of neural network layers (e.g., two or more FSBPs) and on respective two or more signals that are obtained by decomposing the ground-truth, and based on respective two or more second loss functions. The first loss and/or the two or more second losses may be differentiated with respect to one or more parameters of the cross-prediction spectral filtering block 330 and/or one or more parameters of other neural network layers in the filter, in order to compute respective one or more gradients. The one or more gradients are used by an optimization function, such as Stochastic Gradient Descent (SGD) or Adam, to update or train the filter.

In a neural network based filter, there may be one or more instances of the cross-prediction spectral filtering block 330 described in this embodiment. Two different instances of the cross-prediction spectral filtering block 330 may share none, some or all of the parameters that parametrize those instances, where sharing parameters among different instances refers to assigning the same value to corresponding parameters of those instances. In one example, a neural network based filter comprises only one instance of the cross-prediction spectral filtering block 330 and comprises also other neural network layers and operations. In another example, a neural network based filter comprises several instances of the cross-prediction spectral filtering block 330, where the several instances do not share parameters, and comprises also other neural network layers and operations.

FIG. 3f illustrates an example of this embodiment, where a neural network based filter comprises only one instance of the cross-prediction spectral filtering block 330.

In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input \tilde{x} of the filter; for example, x is an uncompressed picture given as an input to a video encoder, and \tilde{x} is a noisy picture that is generated by the video encoder or a video decoder based on \tilde{x}.

The input \tilde{x} is provided as an input to an instance of the cross-prediction spectral filtering block 330. The input to the cross-prediction spectral filtering block 330 is input to a decompose block 303, which decomposes it into two signals \tilde{x}_{HF} and \tilde{x}_{LF}, where \tilde{x}_{HF} represents the high-frequency information of \tilde{x} and \tilde{x}_{LF} represents the low-frequency information of x. The two signals \tilde{x}_{HF} and \tilde{x}_{LF} are input to respective two frequency-specific blocks with prediction denoted as FSBP1 and FSBP2. Each FSBP (e.g., FSBP1) takes two inputs. Each FSBP comprises a first set of NN layers (e.g., HF layers 331), a second set of NN layers (e.g., LF prediction 332) and a third set of NN layers (e.g., Res-HF layers).

In the first frequency-specific block with prediction FSBP1 a first input is a decomposed input (e.g., \tilde{x}_{HF}), and a second input is an intermediate output of the other FSBP (e.g., an intermediate output of FSBP2, generated by HF prediction 335), that represents a prediction of the decomposed input (e.g., prediction of \tilde{x}_{HF}). The first set of NN layers (e.g., HF layers 331) takes as input a decomposed input (e.g., \tilde{x}_{HF}) and outputs a first output. The second input (e.g., the prediction of the decomposed input) is subtracted from the first output, obtaining a residual (e.g., \hat{r}_{HF}). The second set of NN layers (e.g., LF prediction 332) takes as input the first output and outputs a second output that represents an intermediate output of this FSBP, i.e., the prediction of the decomposed input for the other FSBP (e.g., for FSBP2). The third set of NN layers (e.g., Res-HF layers 333) takes as input the residual, and outputs a third output. The third output is added to the first output to form a fourth output \hat{x}_{HF} which represents the output of the first FSBP1.

In the second frequency-specific block with prediction FSBP2 a first input is a decomposed input (e.g., \tilde{x}_{LF}), and a second input is an intermediate output of the other FSBP (e.g., an intermediate output of FSBP1, generated by LF prediction 332), that represents a prediction of the decomposed input (e.g., prediction of \tilde{x}_{LF}). The first set of NN layers (e.g., LF layers 334) takes as input a decomposed input (e.g., \tilde{x}_{LF}) and outputs a first output. The second input (e.g., the prediction of the decomposed input) is subtracted from the first output, obtaining a residual (e.g., \hat{r}_{LF}). The second set of NN layers (e.g., LF prediction 335) takes as input the first output and outputs a second output that represents an intermediate output of this FSBP, i.e., the prediction of the decomposed input for the other FSBP (e.g., for FSBP1). The third set of NN layers (e.g., Res-LF layers 336) takes as input the residual, and outputs a third output. The third output is added to the first output to form a fourth output \hat{x}_{LF} which represents the output of the FSBP2.

The outputs of the two FSBPs are combined by means of a combination block 313 that performs a combination operation, obtaining an intermediate picture \hat{x}ᵢₙₜₑᵣ. In one example, the combination may take as input also the two signals \tilde{x}_{HF} and \tilde{x}_{LF}. In another example, the combination may take as input also the signal \tilde{x}. The intermediate picture \hat{x}ᵢₙₜₑᵣ may optionally be input to a fourth set of layers denoted as “HF+LF layers” 314, obtaining a fourth output that represents the output \hat{x} of the cross-prediction spectral filtering block 330. Alternatively, when the fourth set of layers is not used, the intermediate filtered image \hat{x}ᵢₙₜₑᵣ represents the output \hat{x} of the cross-prediction spectral filtering block 330.

During training, the output \hat{x} of the cross-prediction spectral filtering block 330 and the ground-truth x are used to compute a first loss, for example based on the L2 loss function. Optionally a second and third losses are computed as follows: the ground-truth \tilde{x} is decomposed by the decompose block 303 into the high-frequency signal x_{HF} and the low-frequency signal x_{LF}; the differentiable decompose block 302 and the decompose block 303 may perform the same or substantially the same operation. For example, both the differentiable decompose block 302 and the decompose block 303 may decompose their input signal into two signals of same or substantially the same frequency bands; the second loss is computed by the HF loss block 317 based on \hat{x}_{HF}, x_{HF} and, for example, based on an L1 loss function; the third loss is computed by the LF loss block 318 based on \hat{x}_{LF}, x_{LF} and, for example, based on an L2 loss function. The first loss and, eventually the second and third losses are used for training one or more parameters of the cross-prediction spectral filtering block 330.

### Using Different Filters for Different Frequency Bands

In one embodiment, spectral information is leveraged by using, within a filter or a filtering process, different frequency-specific filters (or FSFs) for different frequency bands. An input may be decomposed into two or more frequency bands, obtaining respective two or more decomposed inputs. The two or more decomposed inputs may be processed by respective two or more frequency-specific filters. The outputs of the two or more filters may be combined, obtaining a combined output. The combined output may be processed by a final set of neural network layers.

The whole system that comprises the above operations and steps is referred here simply as the filter, and it is to be understood that the frequency-specific filters and the filter (or filtering process) are two separate concepts in principle, as the frequency-specific filters are comprised within the filter (or filtering process). In other words, a filter may comprise one or more frequency-specific filters.

During training, a first loss may be computed based at least on the combined output or on the output of the final set of neural network layers, and based on a first loss function. Two or more second losses may be computed based at least on the outputs of the respective two or more filters and on respective two or more signals that are obtained by decomposing the ground-truth, and based on respective two or more second loss functions. The first loss and/or the two or more second losses may be differentiated with respect to one or more parameters of the two or more filters and/or one or more parameters of other neural network layers such as the final set of neural network layers, in order to compute respective one or more gradients. The one or more gradients are used by an optimization function, such as Stochastic Gradient Descent (SGD) or Adam, to update or train the filters and other neural network layers.

FIG. 3g illustrates an example of this embodiment.

In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input x of the filter; for example, x is an uncompressed picture given as input to a video encoder, and \tilde{x} is a noisy picture that is generated by the video encoder or a video decoder based on x.

The input \tilde{x} is provided to a decompose block 303 which decomposes it into two signals \tilde{x}_{HF} and \tilde{x}_{LF}, where \tilde{x}_{HF} represents the high-frequency information of \tilde{x} and \tilde{x}_{LF} represents the low-frequency information of \tilde{x}. A first filter 341, denoted as “HF filter”, takes the high-frequency signal \tilde{x}_{HF} as input and outputs a first output \hat{x}_{HF}. A second filter 342, denoted as “LF filter”, takes the low-frequency signal \tilde{x}_{LF} as input and outputs a second output \hat{x}_{LF}. The first output and second output are combined by means of a combination block 313 that performs a combination operation, obtaining an intermediate picture \hat{x}ᵢₙₜₑᵣ. In one example, the combination may take as input also the two signals \tilde{x}_{HF} and \tilde{x}_{LF}. In another example, the combination may also take as input the signal \tilde{x}. The intermediate picture \hat{x}ᵢₙₜₑᵣ may optionally be input to a third filter denoted as “HF+LF filter” 314, obtaining a third output that represents the output \hat{x} of the filter. Alternatively, when the third filter is not used, the intermediate filtered image \hat{x}ᵢₙₜₑᵣ represents the output \hat{x} of the filter.

During training, the output \hat{x} of the filter and the ground-truth x are used to compute a first loss, for example based on the L2 loss function. Optionally a second and third losses are computed as follows: the ground-truth \tilde{x} is decomposed by the decompose block 303 into the high-frequency signal x_{HF} and the low-frequency signal x_{LF}; the differentiable decompose block 302 and the decompose block 303 may perform the same or substantially the same operation. For example, both the differentiable decompose block 302 and the decompose block 303 may decompose their input signal into two signals of the same or substantially the same frequency bands; the second loss is computed by the HF loss block 315 based on \hat{x}_{HF}, x_{HF} and, for example, based on an L1 loss function; the third loss is computed by the LF loss block 316 based on \hat{x}_{LF}, x_{LF} and, for example, based on an L2 loss function. The first loss and, eventually the second and third losses are used for training one or more parameters of the filter.

Using Different Filters for Different Frequency Bands, with Exchange of Information Between Different Frequency Bands

In one embodiment, spectral information is leveraged by using, within a filter or a filtering process, different frequency-specific filters for different frequency bands. The input may be decomposed into two or more frequency bands, obtaining respective two or more decomposed inputs. The two or more decomposed inputs may be processed by respective two or more filter blocks, denoted as frequency-specific filter blocks (FSFBs). Each frequency-specific filter block takes a decomposed input and an intermediate output of another frequency-specific filter block. Each frequency-specific filter block may comprise a first set of layers, a second set of layers and a third set of layers. The first filter takes as input the input to the frequency-specific filter block and outputs a first output. The second set of layers takes as input the decomposed input to the frequency-specific filter block and outputs a second output. The third filter takes as input the first output and an intermediate output of another frequency-specific filter block (which is the output of the second set of layers in another frequency-specific filter block), and outputs a third output which represents the output of the frequency-specific filter block. The outputs of the two or more frequency-specific filter blocks may be combined, obtaining a combined output. The combined output may be processed by a final set of neural network layers.

The whole system that comprises the above operations and steps is referred here simply as a filter or a filter arrangement, and it is to be understood that the frequency-specific filters (or frequency-specific filter blocks) and the filter (or filtering process) are two separate concepts in principle, as the frequency-specific filters (or frequency-specific filter blocks) are comprised within the filter (or filtering process).

During training, a first loss may be computed based at least on the combined output or on the output of the final set of neural network layers, and based on a first loss function. Two or more second losses may be computed based at least on the outputs of the respective two or more frequency-specific filter blocks and on respective two or more signals that are obtained by decomposing the ground-truth, and based on respective two or more second loss functions. The first loss and/or the two or more second losses may be differentiated with respect to one or more parameters of the two or more frequency-specific filter blocks and/or one or more parameters of other neural network layers such as the final set of neural network layers, in order to compute respective one or more gradients. The one or more gradients are used by an optimization function, such as Stochastic Gradient Descent (SGD) or Adam, to update or train the filters and other neural network layers.

FIG. 3h illustrates an example of this embodiment.

In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input \tilde{x} of the filter; for example, x is an uncompressed picture given as input to a video encoder, and \tilde{x} is a noisy picture that is generated by the video encoder or a video decoder based on x.

The input \tilde{x} is provided to a decompose block 303, which decomposes it into two signals \tilde{x}_{HF} and \tilde{x}_{LF}, where \tilde{x}_{HF} represents the high-frequency information of \tilde{x} and \tilde{x}_{LF} represents the low-frequency information of \tilde{x}. The two signals \tilde{x}_{HF} and \tilde{x}_{LF} are input to respective two frequency-specific filter blocks denoted as FSFB1 and FSFB2. Each FSFB (e.g., FSFB1) takes two inputs, where a first input is a decomposed input, and a second input is an intermediate output of the other FSFB (e.g., FSFB2). Each FSFB comprises a first set of layers (e.g., HF filter, LF filter), a second set of layers (e.g., HF-to-LF filter, LF-to-HF filter) and a third set of layers (e.g., HF filter2, LF filter2).

In the first frequency-specific filter block FSFB1 the first set of layers 351 takes as input the input (e.g., \tilde{x}_{HF}) to the FSFB1 and outputs a first output. The second set of layers 352 takes as input the input (e.g., \tilde{x}_{HF}) to the FSFB1 and outputs a second output that represents an intermediate output of this FSFB1. The third set of layers 353 takes as input the first output and the intermediate output of the other FSFB1, and outputs a third output which represents the output of this FSFB1.

In the second frequency-specific filter block FSFB2 the first set of layers 354 takes as input the input (e.g., \tilde{x}_{LF}) to the FSFB2 and outputs a first output. The second set of layers 355 takes as input the input (e.g., \tilde{x}_{LF}) to the FSFB2 and outputs a second output that represents an intermediate output of this FSFB2. The third set of layers 356 takes as input the first output and the intermediate output of the other FSFB2, and outputs a third output which represents the output of this FSFB2.

The outputs of the two FSFBs are combined by means of a combination block 313 that performs a combination operation, obtaining an intermediate picture \hat{x}ᵢₙₜₑᵣ. In one example, the combination may take as input also the two signals \tilde{x}_{HF} and \tilde{x}_{LF}. In another example, the combination may take as input also the signal \tilde{x}. The intermediate picture \hat{x}ᵢₙₜₑᵣ may optionally be input to a fourth set of layers 314 denoted as “HF+LF filter”, obtaining a fourth output that represents the output x of the filter. Alternatively, when the fourth set of layers is not used, the intermediate filtered image \hat{x}ᵢₙₜₑᵣ represents the output \hat{x} of the filter.

During training, the output \hat{x} of the filter and the ground-truth x are used to compute a first loss, for example based on the L2 loss function 315. Optionally a second and third losses are computed as follows: the ground-truth \tilde{x} is decomposed by the decompose block 316 into the high-frequency signal x_{HF} and the low-frequency signal x_{LF}; the decompose block 303 and the decompose block 316 may perform the same or substantially the same operation. For example, both the decompose block 303 and the decompose block 316 may decompose their input signal into two signals of same or substantially the same frequency bands; the second loss is computed by the HF loss block 317 based on \hat{x}_{HF}, x_{HF} and, for example, based on an L1 loss function; the third loss is computed by the LF loss block 318 based on \hat{x}_{LF}, x_{LF} and, for example, based on an L2 loss function. The first loss and, eventually the second and third losses are used for training one or more parameters of the filter.

Using Different Filters for Different Frequency Bands, with Prediction of a Frequency Band Based on Another Frequency Band

In one embodiment, spectral information is leveraged by using, within a filter or a filtering process, different frequency-specific filters for different frequency bands. The input may be decomposed into two or more frequency bands, obtaining respective two or more decomposed inputs. The two or more decomposed inputs may be processed by respective two or more filter blocks, denoted as frequency-specific filter blocks with prediction (FSFBPs). An FSFBP may comprise a first set of layers, a second set of layers and a third set of layers. An FSFBP takes as input a decomposed input and a prediction of the decomposed input, where the prediction of the decomposed input may be an intermediate output of another FSFBP. The first set of layers takes as input the decomposed input and outputs a first output. The prediction of the decomposed input is subtracted from the first output, obtaining a residual. The second set of layers takes as input the first output and outputs a second output which represents a prediction of a decomposed input that is input to another FSFBP. The third set of layers takes as input the residual and outputs a third output. The third output is added to the first output to form a fourth output which represents the output of the FSFBP. The outputs of the two or more FSFBPs may be combined, obtaining a combined output. The combined output may be processed by a final set of neural network layers.

The whole system that comprises the above operations and steps is referred here simply as the filter, and it is to be understood that the frequency-specific filters and the filter (or filtering process) are two separate concepts in principle, as the frequency-specific filters are comprised within the filter or filtering process.

During training, a first loss may be computed based at least on the combined output or on the output of the final set of neural network layers, and based on a first loss function. Two or more second losses may be computed based at least on the outputs of the respective two or more frequency-specific filters and on respective two or more signals that are obtained by decomposing the ground-truth, and based on respective two or more second loss functions. The first loss and/or the two or more second losses may be differentiated with respect to one or more parameters of the two or more frequency-specific filters and/or one or more parameters of other neural network layers such as the final set of neural network layers, in order to compute respective one or more gradients. The one or more gradients are used by an optimization function, such as Stochastic Gradient Descent (SGD) or Adam, to update or train the filters and other neural network layers.

FIG. 3i illustrates an example of this embodiment.

In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input \tilde{x} of the filter; for example, x is an uncompressed picture given as input to a video encoder, and \tilde{x} is a noisy picture that is generated by the video encoder or a video decoder based on x.

The input \tilde{x} is provided to a decompose block 303, which decomposes it into two signals \tilde{x}_{HF} and \tilde{x}_{LF}, where \tilde{x}_{HF} represents the high-frequency information of \tilde{x} and \tilde{x}_{LF} represents the low-frequency information of \tilde{x}. The two signals \tilde{x}_{HF} and \tilde{x}_{LF} are input to respective two frequency-specific filter blocks with prediction denoted as FSFBP1 and FSFBP2. Each FSFBP (e.g., FSFBP1) takes two inputs, where a first input is a decomposed input (e.g., \tilde{x}_{HF}), and a second input is an intermediate output of the other FSFBP (e.g., an intermediate output of FSFBP2, generated by HF prediction 365), that represents a prediction of the decomposed input (e.g., prediction of \tilde{x}_{HF}). Each FSFBP comprises a first set of layers (e.g., HF filter 361), a second set of layers (e.g., LF prediction 362) and a third set of layers (e.g., Res-HF filter 363).

In the first frequency-specific filter block with prediction FSFBP1 the first set of layers (e.g., HF filter 361) takes as input a decomposed input (e.g., \tilde{x}_{HF}) and outputs a first output. The prediction of the decomposed input is subtracted from the first output, obtaining a residual (e.g., \hat{r}_{HF}). The second set of layers (e.g., LF prediction 362) takes as input the decomposed input (e.g., \tilde{x}_{HF}) and outputs a second output that represents an intermediate output of this FSFBP1, i.e., the prediction of the decomposed input for the other FSFBP (e.g., for FSFBP2). The third set of layers (e.g., Res-HF filter 363) takes as input the residual, and outputs a third output. The third output is added to the first output to form a fourth output which represents the output of the FSFBP1.

In the second frequency-specific filter block with prediction FSFBP2 the first set of layers (e.g., HF filter 364) takes as input a decomposed input (e.g., \tilde{x}_{LF}) and outputs a first output. The prediction of the decomposed input is subtracted from the first output, obtaining a residual (e.g., \hat{r}_{LF}). The second set of layers (e.g., LF prediction 365) takes as input the decomposed input (e.g., \tilde{x}_{LF}) and outputs a second output that represents an intermediate output of this FSFBP2, i.e., the prediction of the decomposed input for the other FSFBP (e.g., for FSFBP1). The third set of layers (e.g., Res-HF filter 366) takes as input the residual, and outputs a third output. The third output is added to the first output to form a fourth output which represents the output of the FSFBP2.

The outputs of the two FSFBPs is combined by means of a combination block 313 that performs a combination operation, obtaining an intermediate picture \hat{x}ᵢₙₜₑᵣ. In one example, the combination may take as input also the two signals \tilde{x}_{HF} and \tilde{x}_{LF}. In another example, the combination may take as input also the signal \tilde{x}. The intermediate picture \hat{x}ᵢₙₜₑᵣ may optionally be input to a fourth set of layers 314 denoted as “HF+LF layers”, obtaining a fifth output that represents the output \hat{x} of the filter. Alternatively, when the fourth set of layers is not used, the intermediate filtered image \hat{x}ᵢₙₜₑᵣ represents the output \hat{x} of the filter.

During training, the output \hat{x} of the filter and the ground-truth \tilde{x} are used to compute a first loss, for example based on the L2 loss function. Optionally a second and third losses are computed as follows: the ground-truth k is decomposed by the decompose block 303 into the high-frequency signal x_{HF} and the low-frequency signal x_{LF}; the decompose block 303 and the decompose block 316 may perform the same or substantially the same operation. For example, both the decompose block 303 and the decompose block 316 may decompose their input signal into two signals of same or substantially the same frequency bands; the second loss is computed by the HF loss block 315 based on \hat{x}_{HF}, x_{HF} and, for example, based on an L1 loss function; the third loss is computed by the LF loss block 316 based on \hat{x}_{LF}, x_{LF} and, for example, based on an L2 loss function. The first loss and, eventually the second and third losses are used for training one or more parameters of the filter.

Decomposition to Frequency Bands in Combination with Scalable Video/Image Coding

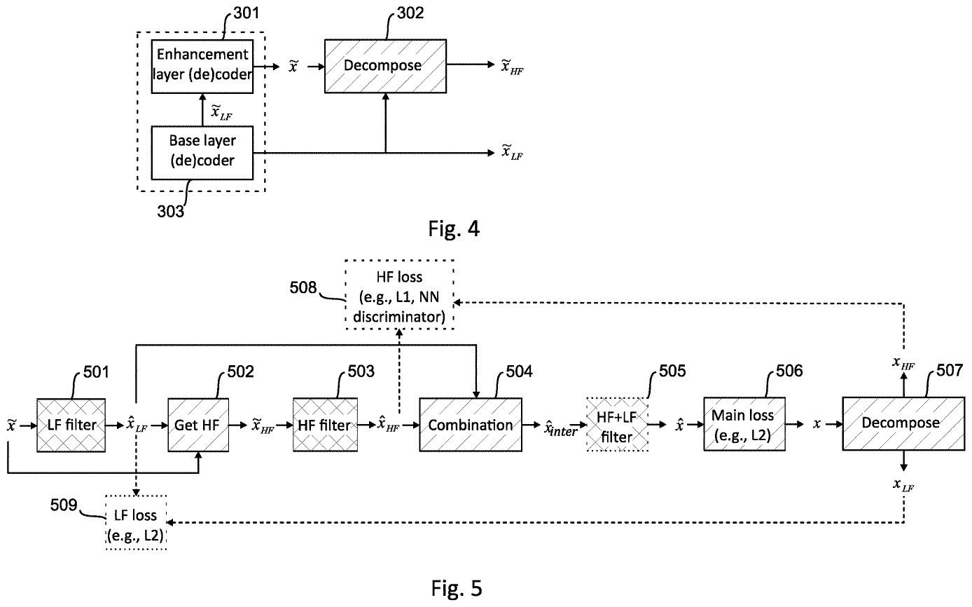

Any of the presented embodiments may be used with scalable image/video coding where the decomposition block is adapted to operate with reconstructed signal of scalability layers as described in this embodiment and illustrated in FIG. 4.

Even though the illustration of FIG. 4 indicates that the decomposition and the subsequent filtering would not be within the scalable image/video (de)coder, it is to be understood that the filtering described in other embodiments may be in-loop filtering and both the filtering and decomposition may be considered to be present within the scalable image/video (de)coder.

In the case of in-loop filtering the signal \tilde{x}_{LF} may represent an intermediate reconstructed base-layer picture and \tilde{x} may represent an intermediate reconstructed enhancement-layer picture. In the case of post-filtering the signal \tilde{x}_{LF} may represent a reconstructed base-layer picture and \tilde{x} may represent a reconstructed enhancement-layer picture. \tilde{x}_{LF} is hence available without decomposition.

The decompose operation may essentially be a sample-wise subtraction of \tilde{x}_{LF} from \tilde{x}. If \tilde{x}_{LF} and \tilde{x} have different resolutions, the decompose operation may include resampling, such as upsampling of \tilde{x}_{LF} to the resolution of \tilde{x}.

The base layer (de)coder may, for example, use coarser quantization of transform coefficients compared to the quantization used by the enhancement layer (de)coder and/or the spatial resolution of the pictures of the base layer (de)coder may be lower than the spatial resolution of the pictures of the enhancement layer (de)coder.

### Using Different Filters for Different Frequency Bands, in Cascade

In one embodiment, spectral information is leveraged by processing signals of different frequency bands at different sequential stages. An input may first be processed by a first frequency-specific filter, obtaining a first output of a first frequency band. For example, the first output may comprise a signal of a low-frequency band. The first output and the input may be used to obtain a signal of a second frequency band, where the second frequency band may be different from the first frequency band. For example, the second frequency band may be a high-frequency band. The signal of the second frequency band may be processed by a second frequency-specific filter, obtaining a second output with the second frequency band. The first output and the second output may be combined, obtaining a combined output of both the first frequency band and the second frequency band. The output of the combination may optionally be input to a final filter or a final set of neural network layers.

Some or all of the above steps may be repeated several times, obtaining a longer chain of sequential steps and, thus, more frequency bands will be considered.

The whole system that comprises the above operations and steps is referred here simply as the filter, and it is to be understood that the frequency-specific filters and the filter are two separate concepts in principle, as the frequency-specific filters are comprised within the filter.

During training, a first loss may be computed based at least on the combined output or on the output of the final set of neural network layers, and based on a first loss function. Two second losses may be computed based at least on the outputs of the first and second frequency-specific filters and on respective two or more signals that are obtained by decomposing the ground-truth, and based on respective two or more second loss functions. The first loss and/or the two or more second losses may be differentiated with respect to one or more parameters of the first and second frequency-specific filters and/or one or more parameters of other neural network layers such as the final set of neural network layers, in order to compute respective one or more gradients. The one or more gradients are used by an optimization function, such as Stochastic Gradient Descent (SGD) or Adam, to update or train the filters and other neural network layers.

FIG. 5 illustrates an example of this embodiment.

In this figure, \tilde{x} is an input to the filter, such as a noisy picture to be filtered. If the filter is an in-loop filter, \tilde{x} may be the output of a previous filter in the filtering chain or may be the input to the filtering chain. If the filter is a post-processing filter, \tilde{x} may be a decoded picture. x is a ground-truth for the input x of the filter; for example, x is an uncompressed picture given as input to a video encoder, and \tilde{x} is a noisy picture that is generated by the video encoder or a video decoder based on x.

The input \tilde{x} is provided to a first frequency-specific filter 501 denoted as “LF filter”, obtaining a first output \hat{x}_{LF} that represents the low-frequency information of \tilde{x}. The first output \hat{x}_{LF} and the input \tilde{x} may be used to obtain 502 a high-frequency signal \tilde{x}_{HF}. For example, \tilde{x}_{HF} may be obtained by subtracting \hat{x}_{LF} from \tilde{x}. Then, \tilde{x}_{HF} is processed by a second frequency-specific filter 503 denoted as “HF filter”, obtaining a second output \hat{x}_{HF} that represents a high-frequency signal. The first output and the second output may be combined 504, obtaining a combined output of the low-frequency signal and the high-frequency signal. For example, the combination may be based on a summation operation. The combined output may be also referred to as an intermediate output \hat{x}ᵢₙₜₑᵣ. The intermediate output \hat{x}ᵢₙₜₑᵣ may optionally be input to a third set of layers 505 denoted as “HF+LF filter”, obtaining a third output that represents the output \hat{x} of the filter. Alternatively, when the third set of layers is not used, the intermediate filtered image \hat{x}ᵢₙₜₑᵣ represents the output x of the filter.

During training, the output \hat{x} of the filter and the ground-truth x are used to compute a first loss 506, for example based on the L2 loss function. Optionally a second and third losses are computed as follows: the ground-truth \tilde{x} is decomposed by the decompose block 507 into the high-frequency signal x_{HF} and the low-frequency signal x_{LF}; a second loss is computed by the HF loss block 508 based on \hat{x}_{HF}, x_{HF} and, for example, based on an L1 loss function; a third loss is computed by the LF loss block 509 based on \hat{x}_{LF}, x_{LF} and, for example, based on an L2 loss function. The first loss and, eventually the second and third losses are used for training one or more parameters of the filter.

### On Coefficients for the Combination Operation

In any of the previous embodiments where a combination is performed between two or more signals of different frequency bands, the combination operation may take as input one or more coefficients that may be used to select and/or to weight the two or more signals.

In one example, a low-frequency signal and a high-frequency signal are combined by the combination operation by means of a linear combination, where two respective coefficients are real-valued and are used for weighting the contribution of each of the two signals.

In any of the previous embodiments where a combination is performed between two or more signals of different frequency bands, the combination operation may be performed two times, where a first combination operation assigns more importance or weight (e.g., a higher coefficient) to a first set of signals (e.g., signals of a first frequency band) than to a second set of signals, and where the second combination operation assigns more importance or weight (e.g., a higher coefficient) to the second set of signals (e.g., signals of a second frequency band) than to the first set of signals. The output of the first combination operation (or data derived from the output of the first combination operation) may be used as a reference picture for a prediction process within a decoder; the output of the second combination operation (or data derived from the output of the second combination operation) may be used as an output picture. An encoder may indicate, in or along a bitstream, that such combination operation is performed twice per picture, and a decoder may decode, from or along a bitstream, that such combination operation is performed twice per picture. The indication may be present, for example, in a sequence-level syntax structure, such as a sequence parameter set, or a picture-level syntax structure, such as a picture header or a picture parameter set.

In an embodiment, any of the previous embodiments where a combination is performed between two or more signals of different frequency bands, the combination operation may be performed for a picture at a time when it is used as a reference picture for inter prediction. The reference picture stored in the decoded picture buffer may be regarded to represent the signal x, whereas the filtered signal x is formed as a part of the process to generate a prediction signal at a time when the picture is used as a reference for inter prediction. The importance or weight may be determined and indicated, by an encoder, for the reference picture or may be decoded from the bitstream, by a decoder, for a reference picture. The importance or weight for the same reference picture need not be the same between different slices or pictures that are using the reference picture as a reference for inter prediction.

In one embodiment, the coefficients may be predetermined and fixed.

### Signalling Aspects

In the following, some signalling aspects will be described in more detail, in accordance with some embodiments.

In an embodiment, an encoder may signal information to a decoder about the ranges of the frequency bands (i.e. the first frequency band, the second frequency band, and optionally one or more other frequency bands), and/or the number of frequency bands, and/or coefficients for combining two or more signals of different frequency bands.

In particular, regarding the coefficients, an indication about the coefficients may be signalled from an encoder to a decoder. In one example, an encoder may indicate which of a predetermined set of coefficients should be used in the combination. In another example, an encoder may indicate one or more coefficients, or an adjustment to one or more predetermined coefficients.

Such signalling or indications may be carried in-band or out-of-band. In one example, they may be part of one or more SEI messages. In another example, they may be part of a picture header or a slice header. In yet another example, signalling or indications are part of an adaptation parameter set for neural-network filtering.

### Training Based on Different Frequency Bands for Different Training Stages

In one embodiment, at a training phase, there may be two or more training stages, where at each stage the input data and the ground-truth data are obtained via a frequency-based pre-processing process, and where the frequency-based pre-processing processes performed at different stages are different with respect to the frequency bands that are considered in those processes.

In one example, the frequency-based pre-processing process may comprise performing a wavelet decomposition on the input data and on the ground-truth data, selecting a first decomposed input data and a first decomposed ground-truth data corresponding to a first set of frequency bands (e.g., low-frequency bands), and using those data for training the NN in a first training stage; then, selecting a second decomposed input data and a second decomposed ground-truth data corresponding to a second set of frequency bands (e.g., high-frequency bands), and using those data for training the NN in a second training stage.

### Other Embodiments

In any of the previous embodiments, where one or more first signals of respective first one or more frequency bands are filtered differently, one or more second signals of respective second one or more frequency bands may be left unfiltered (e.g., no filtering is applied to those second signals, thus they are left unmodified). Then, the filtered one or more first signals may be combined with the one or more second signals.

In one embodiment, a neural network based filter may comprise one or more neural network blocks, denoted as frequency-adaptive blocks (FABs), where each frequency-adaptive block comprises two or more parallel branches. The two or more parallel branches comprise respective two or more sets of neural networks layers, where each set of NN layers receives a certain portion of the input to the frequency-adaptive block (e.g., different sets of NN layers, or different branches, receive different portions of the input to the frequency-adaptive block) and where the outputs of all sets of NN layers are combined to form the output of the frequency-adaptive block.

In this embodiment, the layers in different branches may differ by one or more properties, such as kernel size or layer type. In one example, one or more first branches use convolutional layers with kernel size 3×3, one or more second branches use convolutional layers with kernel size 5×5, one or more third branches use deformable convolutional layers, one or more fourth branches use separable convolutional layers.

In one embodiment, the two or more inputs to the respective two or more branches comprise different channels of the tensor that is input to the frequency-adaptive block. In one example, the frequency-adaptive block comprises two branches; the input tensor to the frequency-adaptive block comprises 64 channels; 32 channels will be input to a first branch and other 32 channels will be input to a second branch.

It should be noted that, in this specification, the terms “picture”, “image”, and “frame” may be used interchangeably. Also the terms “machine vision”, “machine vision task”, “machine task”, “machine analysis”, “machine analysis task”, “computer vision”, “computer vision task”, “task network” and “task” may be used interchangeably. Furthermore, the terms “machine consumption” and “machine analysis” may be used interchangeably, as well as the terms “post-filter”, “post-processing filter” and “postprocessing filter” may be used interchangeably.

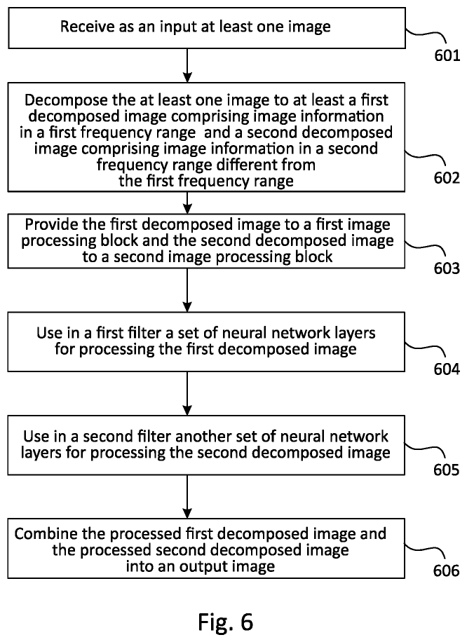

The method according to an embodiment is shown in FIG. 6. The method generally comprises receiving 601 as an input at least one image; decomposing 602 the image to at least a first decomposed image comprising image information in a first frequency range and a second decomposed image comprising image information in a second frequency range different from the first frequency range; providing 603 the first decomposed image to a first image processing block and the second decomposed image to a second image processing block; using 604 in a first filter a first set of neural network layers for processing the first decomposed image; using 605 in a second filter a second set of neural network layers for processing the second decomposed image; and outputting 606 at least one image formed on the basis of the processed first decomposed image and the processed second decomposed image.

An apparatus according to an embodiment comprises means for receiving as an input a frame of a video presentation and at least one constraint; means for producing by the neural network predictor at least one evaluation value for two or more possible codec configurations based on the input video frame and the at least one constraint; means for using the at least one evaluation value to select a codec configuration among the two or more possible codec configurations; and means for using the selected codec configuration to encode the video frame. The means comprises at least one processor, and a memory including a computer program code, wherein the processor may further comprise processor circuitry. The memory and the computer program code are configured to, with the at least one processor, cause the apparatus to perform the method of FIG. 6 according to various embodiments.

An apparatus according to an embodiment comprises means for receiving an encoded bitstream; means for determining a decoding configuration to be used for decoding the bitstream; means for selecting the determined decoding configuration for decoding the bitstream; means for providing the encoded bitstream to the selected decoding configuration; and means for decoding the encoded bitstream by the selected decoding configuration. The means comprises at least one processor, and a memory including a computer program code, wherein the processor may further comprise processor circuitry. The memory and the computer program code are configured to, with the at least one processor, cause the apparatus to perform the method of FIG. 6 according to various embodiments.

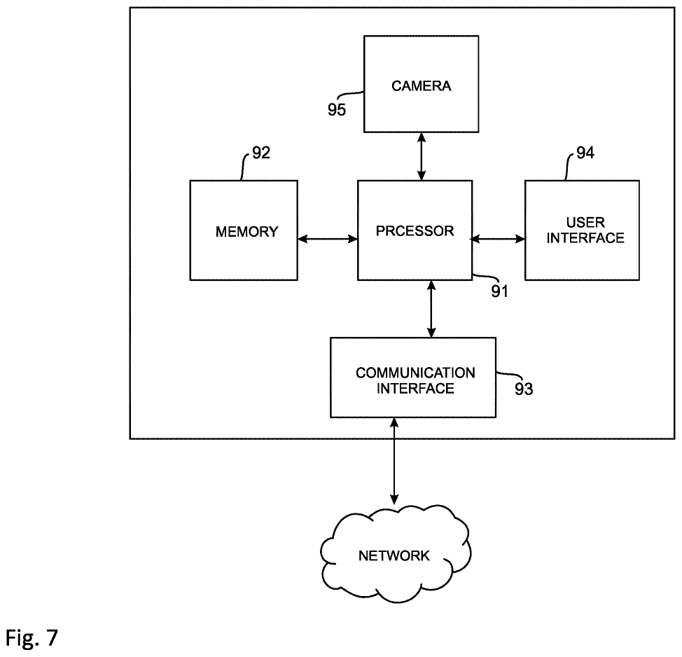

An example of an apparatus is shown in FIG. 7. The apparatus is a user equipment for the purposes of the present embodiments. The apparatus 90 comprises a main processing unit 91, a memory 92, a user interface 94, a communication interface 93. The apparatus according to an embodiment, shown in FIG. 7, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

Some embodiments and examples have been described with reference to VVC encoder and/or VVC decoder. It needs to be understood that equivalently to VVC encoder and/or VVC decoder, a video encoder and a video decoder of any video coding standard or specification may be used in embodiments and examples.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-17. (canceled)

18. An apparatus comprising: at least one processor; and at least one memory storing instructions that, when executed by the at least one processor, cause the apparatus at least to: receive as an input a signal; decompose the signal to at least a first decomposed signal and a second decomposed signal based on one or more properties of the signal;
provide the first decomposed signal and the second decomposed signal to a filter; use in the filter a set of neural network layers for processing the first decomposed signal; use in the filter another set of neural network layers for processing the second decomposed signal; and
obtain one or more output signals based on the processed first decomposed signal and the processed second decomposed signal.

19. The apparatus according to claim 18, said at least one memory storing instructions that, when executed by the at least one processor, cause the apparatus to: decompose the signal to the first decomposed signal and the second decomposed signal based on spectral content of the signal.

20. The apparatus according to claim 18, said at least one memory storing instructions that, when executed by the at least one processor, cause the apparatus to: filter the first decomposed signal and the second decomposed signal to form a first intermediate signal and a second intermediate signal.

21. The apparatus according to claim 20, said at least one memory storing instructions that, when executed by the at least one processor, cause the apparatus to: use the first intermediate signal and the second intermediate signal to obtain the one or more output signals.

22. The apparatus according to claim 21, said at least one memory storing instructions that, when executed by the at least one processor, cause the apparatus to: obtain a ground-truth associated to the input signal; decompose the ground-truth to a first output and a second output; and use the first intermediate signal, the second intermediate signal, the first output and the second output to obtain a first loss and a second loss.

23. The apparatus according to claim 18, said at least one memory storing instructions that, when executed by the at least one processor, cause the apparatus to: obtain a combined output by using the processed first decomposed signal, the processed second decomposed signal, and a combination operation.

24. The apparatus according to claim 23, said at least one memory storing instructions that, when executed by the at least one processor, cause the apparatus to: additionally use one or both of the first decomposed signal and the second decomposed signal to obtain the combined output.

25. The apparatus according to claim 23, said at least one memory storing instructions that, when executed by the at least one processor, cause the apparatus to: use in the combining one or more coefficients.

26. The apparatus according to claim 18, said at least one memory storing instructions that, when executed by the at least one processor, cause the apparatus to: decompose the signal based on a frequency of the signal, wherein the first decomposed signal represents a first frequency range and the second decomposed signal represents a second frequency range.

27. The apparatus according to claim 18, said at least one memory storing instructions that, when executed by the at least one processor, cause the apparatus to: receive auxiliary information for assisting the processing of at least one of the first decomposed signal and the second decomposed signal.

28. The apparatus according to claim 18, said at least one memory storing instructions that, when executed by the at least one processor, cause the apparatus to: receive a first image and a second image as the input signal; and process at least one of the first image and the second image for performing at least one of the following: intra-frame prediction; inter-frame prediction; frame-rate upsampling; encoding; and decoding.

29. The apparatus according to claim 28, said at least one memory storing instructions that, when executed by the at least one processor, cause the apparatus to: use in the set of neural network layers a first set for processing the first decomposed image to form a first intermediate image, a second set for producing a second intermediate image based on the first decomposed image, and a third set for producing the processed first decomposed image based on the first intermediate image and a fourth intermediate image formed by the another set of neural network layers; use in the another set of neural network layers a fourth set for processing the second decomposed image to form a third intermediate image, a fifth set for producing a fourth intermediate image based on the second decomposed image, and a sixth set for producing the processed second decomposed image based on the third intermediate image and the second intermediate image formed by the first set of neural network layers.

30. The apparatus according to claim 29, said at least one memory storing instructions that, when executed by the at least one processor, cause the apparatus to: form in the second set a first prediction of the output image to be used as the second intermediate image; and form in the fifth set a second prediction of the output image to be used as the fourth intermediate image.

31. The apparatus according to claim 28, said at least one memory storing instructions that, when executed by the at least one processor, cause the apparatus to: filter by the set of neural network layers the first decomposed image at the first frequency range; and filter by the another set of neural network layers the second decomposed image at the second frequency range.

32. The apparatus according to claim 26, said at least one memory storing instructions that, when executed by the at least one processor, cause the apparatus to: signal information to a decoder about one or more of the following: the ranges of the frequency bands; the number of frequency bands; and coefficients for combining two or more signals of different frequency bands.

33. The apparatus according to claim 18, said at least one memory storing instructions that, when executed by the at least one processor, cause the apparatus to perform at least one of the following: training the set of neural network layers and the another set of neural network layers; and using the set of neural network layers and the another set of neural network layers for filtering the received signal.

34. A method comprising: receiving as an input a signal; decomposing the signal to at least a first decomposed signal and a second decomposed signal; providing the first decomposed signal and the second decomposed signal to a filter; using in the filter a set of neural network layers for processing the first decomposed signal; using in the filter another set of neural network layers for processing the second decomposed signal; and obtaining one or more output signals based on the processed first decomposed signal and the processed second decomposed signal.

35. The method according to claim 34 further comprising: filtering the first decomposed signal and the second decomposed signal to form a first intermediate signal and a second intermediate signal.

36. The method according to claim 35 further comprising: using the first intermediate signal and the second intermediate signal to obtain the one or more output signals.

37. The method according to claim 36 further comprising: obtaining a ground-truth associated to the input signal; decomposing the ground-truth to a first output and a second output; and using the first intermediate signal, the second intermediate signal, the first output and the second output to obtain a first loss and a second loss.
